(19) United States
(12) Patent Application Publication
(10) Pub. No.: US 2022/0335250 A1
(43) Pub. Date: Oct. 20, 2022

(54) METHODS AND APPARATUSES FOR FINE-GRAINED STYLE-BASED GENERATIVE NEURAL NETWORKS

(71) Applicant: KWAI INC., Palo Alto, CA (US)

(72) Inventors: Xin MIAO, Palo Alto, CA (US); Huayan WANG, Palo Alto, CA (US)

(73) Assignee: KWAI INC., Palo Alto, CA (US)

(21) Appl. No.: 17/234,772

(22) Filed: Apr. 19, 2021

(51) Int. Cl. G06K 9/00; G06T 3/40; G06K 9/46; G06N 20/20

(52) U.S. Cl. CPC G06K 9/00979; G06T 3/4046; G06K 9/4671; G06N 20/20

(57) ABSTRACT

A method and an apparatus for training a generative adversarial network (GAN) and a method and an apparatus for processing an image are provided. The method for training the GAN includes: obtaining a fine-grained style label (FGSL) associated with the image and inputting the FGSL and a latent vector into a style-based generator in the GAN; the style-based generator generating an first output image based on the FGSL and the latent vector; the projection discriminator determining whether the first output image matches the image based on the FGSL; and adjusting one or more parameters of the GAN and regenerating, by the style-based generator, a second output image based on the FGSL, the latent vector, and the adjusted GAN in response to determining that the first output image does not match the image based on the FGSL.

### FIELD

The present application relates to neural networks, and in particular but not limited to, to fine-grained style-based generative neural networks.

### BACKGROUND

To stylize images, most Artificial Intelligence (AI) technologies require manually labeled paired data to train models, such as artists' styled works. The style-based generative neural networks (StyleGANs) blending technique can generate a large number of paired images with high quality when there are only data over style domains. The large number of paired images are then provided to train subsequent models, large or small, in servers or mobile terminals. However, due to varieties within the artists' styled works, outputs generated by the StyleGANs are inconsistent, which provides obstacles in training subsequent models.

Usually, a first generator corresponding to styled works or images is obtained by fine-tuning the styleGANs over small data sets. The StyleGANs have been pre-trained over large data sets before fine-tuning. A third generator is obtained by fusing the first generator and a second generator performing pre-training over normal facial data domains. Then, same noises after sampling are input into the second generator and the third generator and styled images corresponding to normal facial images are generated to train subsequent Pixel2Pixel model. However, the styled images generated accordingly are not fine-grained-wise controllable.

As there are always certain differences among styled works even by a same artist, styled images generated by the generators above always have fine-grained-wise differences accordingly. Because these fine-grained-wise differences are always obtained randomly and uncontrollable, models obtained accordingly are not convenient for efficient communication with product personnel, and thus providing obstacles in training subsequent Pixel2Pixel model.

### SUMMARY

The present disclosure provides examples of techniques relating to controlling fine-grained of styled images generated by a styleGAN model and improving quality of the generated images.

According to a first aspect of the present disclosure, there is provided a method for training a GAN. The method includes obtaining a fine-grained style label (FGSL) associated with an image and inputting the FGSL and a latent vector into a style-based generator in the GAN. The FGSL indicates one or more fine-grained styles of the image, and the GAN includes a projection discriminator.

Further, the method includes that the style-based generator generates a first output image based on the FGSL and the latent vector and the projection discriminator determines whether the first output image matches the image based on the FGSL. Moreover, the method includes adjusting one or more parameters of the GAN and regenerating a second output image based on the FGSL, the latent vector, and the adjusted GAN in response to determining that the first output image does not match the image based on the FGSL.

According to a second aspect of the present disclosure, there is provided a method for processing an image. The method includes obtaining an FGSL associated with the image and inputting the FGSL and a latent vector into a style-based generator in a GAN. The FGSL indicates one or more fine-grained styles of the image. Additionally, the method may include the style-based generator generating an output image based on the FGSL and the latent vector.

According to a third aspect of the present disclosure, there is provided an apparatus for training a GAN. The apparatus includes one or more processors and a memory configured to store instructions executable by the one or more processors. The one or more processors, upon execution of the instructions, are configured to perform acts including obtaining an FGSL associated with an image and inputting the FGSL and a latent vector into a style-based generator in the GAN. The FGSL indicates one or more fine-grained styles of the image, and the GAN includes a projection discriminator.

The one or more processors are configured to perform acts further including generating, by the style-based generator, a first output image based on the FGSL and the latent vector and determining, by the projection discriminator, whether the first output image matches the image based on the FGSL. Moreover, the one or more processors are configured to adjust one or more parameters of the GAN and regenerate a second output image based on the FGSL, the latent vector, and the adjusted GAN in response to determining that the first output image does not match the image based on the FGSL.

According to a fourth aspect of the present disclosure, there is provided an apparatus for processing an image. The apparatus includes one or more processors and a memory configured to store instructions executable by the one or more processors. The one or more processors, upon execution of the instructions, are configured to obtain an FGSL associated with the image and input the FGSL and a latent vector into a style-based generator in a GAN. The FGSL indicates one or more fine-grained styles of the image. Additionally, the one or more processors may be configured to generate an output image based on the FGSL and the latent vector by the style-based generator.

According to a fifth aspect of the present disclosure, there is provided a non-transitory computer readable storage medium, including instructions stored therein, where, upon execution of the instructions by one or more processors, the instructions cause the one or more processors to perform the method according to the first aspect.

According to a sixth aspect of the present disclosure, there is provided a non-transitory computer readable storage medium, including instructions stored therein, where, upon execution of the instructions by one or more processors, the instructions cause the one or more processors to perform the method according to the second aspect.

### BRIEF DESCRIPTION OF THE DRAWINGS

A more particular description of the examples of the present disclosure will be rendered by reference to specific examples illustrated in the appended drawings. Given that these drawings depict only some examples and are not therefore considered to be limiting in scope, the examples will be described and explained with additional specificity and details through the use of the accompanying drawings.

FIG. 1 is a flowchart illustrating an exemplary process of obtaining an FGSL associated with an image in accordance with some implementations of the present disclosure.

FIGS. 2A-2B illustrate examples of FGSLs distributed onto two-dimensional space in accordance with some implementations of the present disclosure.

FIG. 3 is a block diagram illustrating a fine-grained style-based generator in accordance with some implementations of the present disclosure.

FIG. 4 illustrates an example of a first mapping network in accordance with some implementations of the present disclosure.

FIG. 5 illustrates an example of a second mapping network in accordance with some implementations of the present disclosure.

FIG. 6 illustrates an example of a GAN in accordance with some implementations of the present disclosure.

FIG. 7 illustrates an example of a projection discriminator in accordance with some implementations of the present disclosure.

FIG. 8 is a block diagram illustrating an image processing system in accordance with some implementations of the present disclosure.

FIG. 9 is a flowchart illustrating an exemplary process of training a fine-grained style-based GAN in accordance with some implementations of the present disclosure.

FIG. 10 is a flowchart illustrating an exemplary process of processing an image by using a GAN that has been trained according to the method as illustrated in FIG. 9 in accordance with some implementations of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used. For example, it will be apparent to one of ordinary skill in the art that the subject matter presented herein can be implemented on many types of electronic devices with digital video capabilities.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

Throughout the disclosure, the terms “first,” “second,” “third,” and etc. are all used as nomenclature only for references to relevant elements, e.g., devices, components, compositions, steps, and etc., without implying any spatial or chronological orders, unless expressly specified otherwise. For example, a “first device” and a “second device” may refer to two separately formed devices, or two parts, components or operational states of a same device, and may be named arbitrarily.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

As used herein, the term “if” or “when” may be understood to mean “upon” or “in response to” depending on the context. These terms, if appear in a claim, may not indicate that the relevant limitations or features are conditional or optional. For example, a method may comprise steps of: i) when or if condition X is present, function or action X′ is performed, and ii) when or if condition Y is present, function or action Y′ is performed. The method may be implemented with both the capability of performing function or action X′, and the capability of performing function or action Y′. Thus, the functions X′ and Y′ may both be performed, at different times, on multiple executions of the method.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

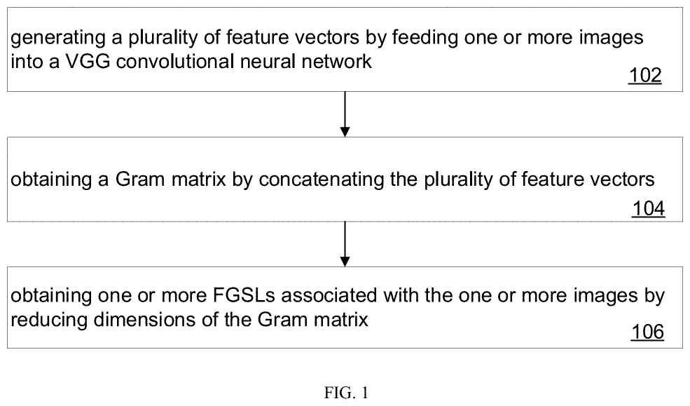

FIG. 1 is a flowchart illustrating an exemplary process of obtaining an FGSL associated with an image in accordance with some implementations of the present disclosure. An image, for example, an artistic image, may have one or more fine-grained styles. The artistic image may be a painting by a specific artist, or an ACG (Anime/Comics/Games) picture. Each image may be provided with an FGSL which is a label representing the one or more fine-grained styles of the image. The FGSL may be obtained by steps as shown in FIG. 1.

In step 102, a plurality of feature vectors are generated by feeding one or more images into a VGG convolutional neural network (CNN).

In some examples, each image is input into the VGG CNN consisting of multiple layers. Each layer may extract a certain feature from the input image. Accordingly, an output of each layer comprises multiple feature maps. The VGG CNN may train each inputted image through all layers and extracts a feature vector in a high-dimension vector space. The feature vector is corresponding to the inputted image. After inputting multiple images into the VGG CNN, the VGG CNN trains the multiple images, and respectively generates multiple feature vectors in the high-dimension vector space.

In some examples, the VGG CNN may be a 19-layer VGG network including 16 convolutional layers and 5 pooling layers.

In some examples, the extracted feature vector may include style representations associated with one or more fine-grained styles of the inputted image. The one or more fine-grained styles may be pre-determined for the image. The fine-grained styles may include color of hair, curviness of hair, brightness of skin, etc.

In step 104, a Gram matrix is obtained by concatenating the plurality of feature vectors obtained in step 102.

In some examples, given each extracted feature vector being 512-dimensional vector, the Gram matrix may be obtained by concatenating the multiple 512-dimensional vectors.

In step 106, one or more FGSLs associated with the one or more images are obtained by reducing dimensions of the Gram matrix.

In some examples, the dimensions of the Gram matrix obtained in step 104 may be reduced by using principal component analysis (PCA) which reduces number of dimensions of the Gram matrix whilst retaining most information.

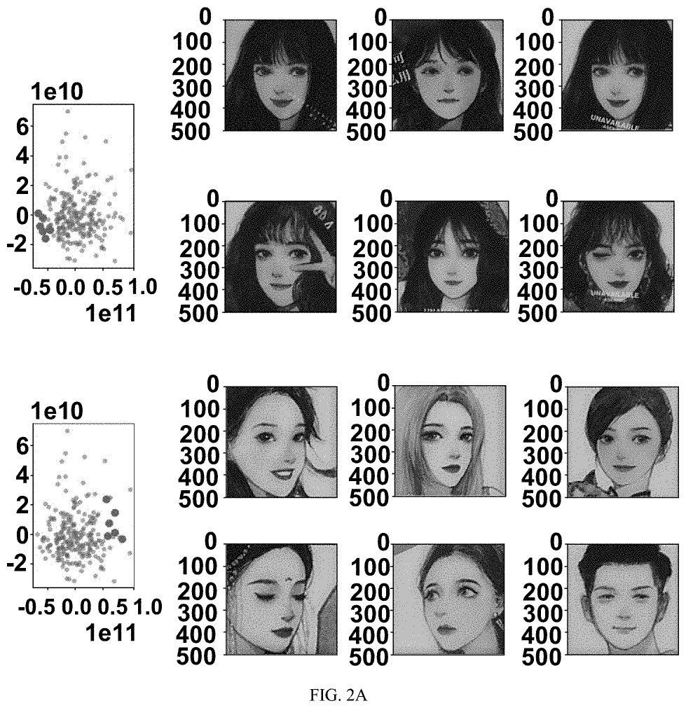

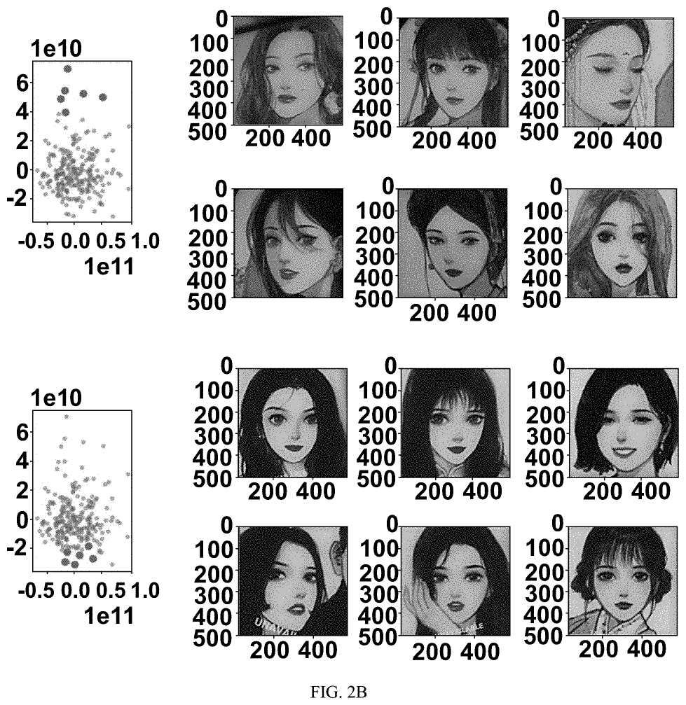

In some examples, the Gram matrix is projected onto two dimensions with t-Distributed Stochastic Neighbor Embedding (TSNE), as shown in FIGS. 2A-2B.

FIGS. 2A-2B illustrate examples of FGSLs distributed onto two-dimensional space in accordance with some implementations of the present disclosure. As shown in FIGS. 2A-2B, four scatterplots including multiple FGSLs show a gradient relationship of multiple images based on one or more fine-grained styles. An FGSL is denoted by a data point in the scatter plot. Distance between every two FGSLs may indicate a style loss/difference between two corresponding images.

As shown in FIGS. 2A-2B, for each scatter plot of four scatter plots, there are six dots corresponding to six images on the right and the six dots are illustrated as six darker and bigger dots compared with other dots in the scatter plot. The relationship among the six images is illustrated in the corresponding scatter plot. Closer two dots in the scatter plot are, more similar or consistent two images corresponding to the two dots are based on the one or more fine-grained styles.

Furthermore, an FGSL may be used manually to control generation of fine-grained styled images after models have been trained. Provided a set of 200 artistic images to be trained, one FGSL corresponding to a particular image among the 200 artistic images is set to be a parameter of the generator, such that all images generated by the generator will be consistent with the fine-grained styles of the particular image.

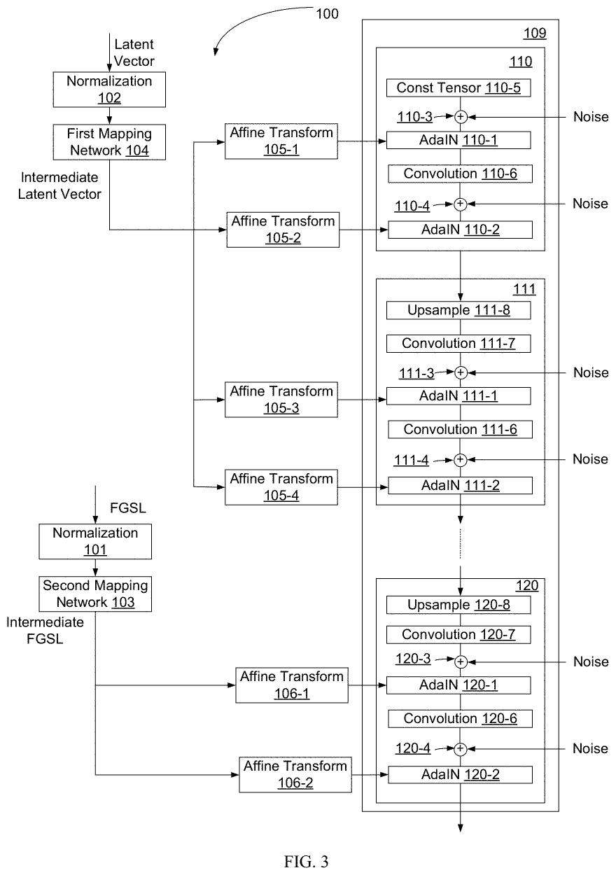

FIG. 3 is a block diagram illustrating a fine-grained style-based generator in accordance with some implementations of the present disclosure. As shown in FIG. 3, a fine-grained style-based generator 100 includes a first mapping network 104, a second mapping network 103, and a synthesis network 109 including multiple layers 110, 111, . . . , 120.

The fine-grained style-based generator 100 may be implemented by a program, a circuitry, or a combination of a program and a circuitry. For example, the fine-grained style-based generator 100 may be implemented using a graphics processing unit (GPU), a central processing unit (CPU), field programmable gate arrays (FPGAs), a tensor processing unit (TPU), digital signal processor (DSP), or any processors.

Inputs of the fine-grained style-based generator 100 may have at least two inputs including the one or more FGSLs obtained in step 106 and a latent vector. The latent vector may be a vector in a latent space.

The fine-grained style-based generator 100 receives the latent vector through the first mapping network 104. The first mapping network 104 generates an intermediate latent vector and sends the intermediate latent vector to a first set of transformers including affine transform layers 105-1, 105-2, 105-3, 105-4 as shown in FIG. 3. The first set of transformers respectively receives the intermediate latent vector, generates a corresponding style signal, and sends the generated style signal to a corresponding normalization layer included in a first layer in the synthesis network 109.

Additionally, the fine-grained style-based generator 100 receives the one or more FGSLs through the second mapping network 103. The second mapping network 103 generates an intermediate FGSL and sends the intermediate FGSL to a second set of transformers including affine transform layers 106-1 and 106-2 as shown in FIG. 3. The second set of transformers respectively receives the intermediate FGSL, generates a corresponding style signal, and sends the generated style signal to a corresponding normalization layer included in a second layer in the synthesis network 109.

In some embodiments, the synthesis network 109 may include multiple layers. The multiple layers may include a first set of layers and a second set of layers. For example, the first set of layers include one or more first layers, and the second set of layers include one or more second layers. The one or more second layers process higher resolution feature maps than the one or more first layers. As a result, the generated style signals corresponding to the latent vector are provided to the one or more first layers in the synthesis network 109 processing lower resolution feature maps, and the generated style signals corresponding to the FGSLs are provided to the one or more second layers in the synthesis network 109 processing higher resolution feature maps.

In some examples, as shown in FIG. 3, an FGSL is inputted into the second mapping network 103 and the second mapping network 103 may generate an intermediate FGSL for the FGSL and send the intermediate FGSL to one or more transformers. The one or more transformers may include affine transform layers 106-1 and 106-2 as shown in FIG. 3.

In one embodiment, before the FGSL is inputted into the second mapping network 103, the FGSL is first inputted into a normalization layer 101, and the output of the normalization layer 101 is sent to the second mapping network 103.

The second mapping network 103 may include multiple layers. FIG. 5 illustrates an example of the second mapping network in accordance with some implementations of the present disclosure. As shown in FIG. 5, the second mapping network 103 includes M fully-connected (FC) layers 103-1, 103-2, 103-3, . . . , 103-M, where M is a positive integer. M may be 6, 8, 10, etc.

In some examples, the second mapping network 103 may be a non-linear mapping network f:V→U. The FGSL inputted into the normalization layer 101 is in the space V and the output of the second mapping network 103 is in the space U. The non-linear mapping network f may consist of eight FC layers. In some examples, dimensionality of the space V or the space U may be set to, but not limited to, 512, for example.

The output of the second mapping network 103 that is relevant to the FGSL inputted to the normalization layer 101 may be the intermediate FGSL in the space U. The intermediate FGSL generated by the second mapping network 103 is then sent to one or more transformers, for example, the affine transform layers 106-1 and the 106-2 shown in FIG. 3.

In some examples, as shown in FIG. 3, the latent vector is inputted into the first mapping network 104 and the first mapping network 104 may generate an intermediate latent vector for the latent vector inputted and send the intermediate latent vector to one or more transformers. The one or more transformers may include affine transform layers 105-1, 105-2, . . . and 105-4 as shown in FIG. 3.

In one example, before the latent vector is inputted into the first mapping network 104, the latent vector is first inputted into a normalization layer 102, and the output of the normalization layer 102 is sent to the first mapping network 104.

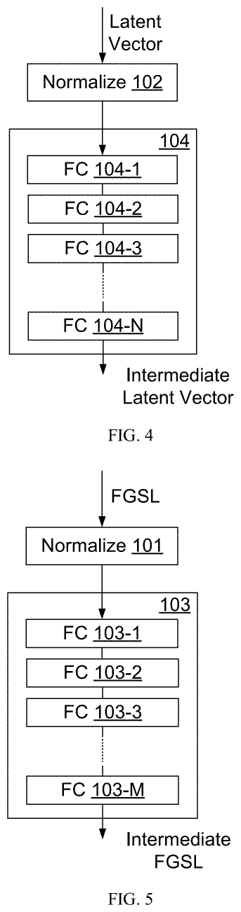

The first mapping network 104 may include multiple layers. FIG. 4 illustrates an example of the first mapping network in accordance with some implementations of the present disclosure. As shown in FIG. 4, the first mapping network 104 includes N FC layers 104-1, 104-2, 104-3, . . . , 104-N, where N is a positive integer. N may be 6, 8, 10, etc.

In some examples, the first mapping network 104 may be a non-linear mapping network h:Z→W. The latent vector inputted into the normalization layer 102 is in the space Z and the output of the first mapping network 104 is in the space W. The non-linear mapping network h may consist of eight FC layers. In some examples, dimensionality of the space Z or the space W may be set to, but not limited to, 512, for example.

The output of the first mapping network 104 that is relevant to the latent vector inputted to the normalization layer 102 may be the intermediate latent vector in the space W. The intermediate latent vector generated by the first mapping network 104 is then sent to one or more transformers, for example, the affine transform layers 105-1, 105-2, . . . , 105-4 shown in FIG. 3. The number of the one or more transformers is not limited to the number as illustrated in FIG. 3.

The synthesis network 109 may include multiple layers. The number of the multiple layers is not limited to the number as illustrated in FIG. 3. The multiple layers included in the synthesis network 109 may include at least two sets of layers. The first set of layers may include one or more first layers, for example, the first layer 110, the first layer 111, etc. The number of the first layers is not limited to the number as illustrated in FIG. 3. The second set of layers may include one or more second layers, for example, the second layer 120, etc. The number of the second layers is not limited to the number as illustrated in FIG. 3. In some examples, the second set of layers process higher resolution feature maps than the first set of layers. In one example, the number of the first set of layers is 12 and the number of the second set of layers is 4. In one example, the number of the first set of layers is 16 and the number of the second set of layers is 4. In some examples, the number of the first set of layers is no greater than the number of the second set of layers.

In a first layer, there may be a plurality of sub-layers. As shown in FIG. 3, the first layer 110 includes a constant tensor 110-5, a first residual sub-layer 110-3, a first normalization sub-layer, a convolution sub-layer 110-6, a second residual sub-layer, and a second normalization sub-layer 110-2.

The first normalization sub-layer may be an adaptive instance normalization (AdaIN) sub-layer 110-1 and the second normalization layer may be an AdaIN sub-layer 110-2. Each AdaIN sub-layer performs an adaptive instance normalization operation which may be defines as equation (1)

$$AdaIN ( {x}_{i} , y ) = {y}_{s , i} \frac{{x}_{i} - μ ( {x}_{i} )}{δ ( {x}_{i} )} + {y}_{b , i} \qquad ( 1 )$$

where xᵢ denotes a feature map received by the AdaIN sub-layer, (yₛ, y_{b}) denotes a style signal generated by an affine transform layer.

In some examples, noise inputs are sent to the first and second residual sub-layers. As shown in FIG. 3, in the first layer 110, a noise input is added to the output of the constant tensor 110-5 and a noise input is added to the output of the convolution sub-layer 110-4.

The first residual sub-layer 110-3 receives two inputs including an input from the constant tensor 110-5 and the noise input, generates an output and sends the output to the first AdaIN sub-layer 110-1. The first AdaIN sub-layer 110-1 sends its output to the convolution sub-layer 110-6. The convolution sub-layer 110-6 may be a 3×3 convolution layer. The output of the convolution sub-layer 110-6 is sent to the second residual sub-layer 110-4. The second residual sub-layer 110-4 receives two inputs including the output of the convolution sub-layer 110-6 and the noise input, generates an output and sends the output to the second AdaIN sub-layer 110-2. The output of the second AdaIN sub-layer 110-2 may be the output of the first layer 110 and may be sent to a following layer in the synthesis network 109, for example, the first layer 111 as shown in FIG. 3. In some examples, the first layer 110 may process feature maps of a resolution of 4×4.

In some examples, a first layer, for example, the first layer 111, may include multiple sub-layers including a upsample sub-layer 111-8, a first convolution sub-layer 111-7, a first residual sub-layer 111-3, a first AdaIN sub-layer 111-1, a second convolution sub-layer 111-6, a second residual sub-layer 111-4, and a second AdaIN sub-layer 111-2.

The upsample sub-layer 111-8 receives an input from the first layer 110 and sends its output to the first convolution sub-layer 111-7. The first convolution sub-layer 111-7 sends its output to the first residual sub-layer 111-3. The first residual sub-layer 111-3 receives two inputs including the output of the first convolution sub-layer 111-7 and the noise input, generates its output and sends the output to the first AdaIN sub-layer 111-1. The first AdaIN sub-layer 111-1 sends its output to the second convolution sub-layer 111-6. The second convolution sub-layer 111-6 receives the output of the first AdaIN sub-layer 111-1 as its input and sends its output to the second residual sub-layer 111-4. The second residual sub-layer 111-4 receives two inputs including the output of the second convolution sub-layer 111-6 and the noise input, generates its output and sends the output to the second AdaIN sub-layer 111-2. The second AdaIN sub-layer 111-2 sends its output to a subsequent layer. The output of the second AdaIN sub-layer 111-2 may be the output of the first layer 111.

As shown in FIG. 3, each AdaIN sub-layer is corresponding to an affine transform layer. Each AdaIN sub-layer receives an input from an affine transform layer. An affine transform layer receives an input from the first mapping network 104 or the second mapping network 103, generates a style signal and sends the generated style signal to its corresponding AdaIN sub-layer in the synthesis network 109. The generated style signal controls the AdaIN operation performed in the corresponding AdaIN sub-layer.

As shown in FIG. 3, the affine transform layer 105-1 receives the intermediate latent vector from the first mapping network 104, generates an output and sends the output to the AdaIN sub-layer 110-1 in the first layer 110. The affine transform layer 105-2 receives the intermediate latent vector from the first mapping network 104, generates an output and sends the output to the AdaIN sub-layer 110-2.

In some examples, the first convolution sub-layer 111-7 or the first convolution sub-layer 111-6 may be a 3×3 convolution layer. The first layer 111 may process feature maps of a resolution of 8×8. In some examples, the one or more first layers may, but not limited to, include the same layer structure as the first layer 111.

In a second layer, there may be a plurality of sub-layers. As shown in FIG. 3, the second layer 120 includes a upsample sub-layer 120-8, a first convolution sub-layer 120-7, a first residual sub-layer 120-3, a first AdaIN sub-layer 120-1, a second convolution sub-layer 120-6, a second residual sub-layer 120-4, and a second AdaIN sub-layer 120-2.

The upsample sub-layer 120-8 receives an input from a previous layer of the second layer 120 and sends its output to the first convolution sub-layer 120-7. The first convolution sub-layer 120-7 sends its output to the first residual sub-layer 120-3. The first residual sub-layer 120-3 receives two inputs including the output of the first convolution sub-layer 120-7 and the noise input, generates its output and sends the output to the first AdaIN sub-layer 120-1. The first AdaIN sub-layer 120-1 sends its output to the second convolution sub-layer 120-6. The second convolution sub-layer 120-6 receives the output of the first AdaIN sub-layer 120-1 as its input and sends its output to the second residual sub-layer 120-4. The second residual sub-layer 120-4 receives two inputs including the output of the second convolution sub-layer 120-6 and the noise input, generates its output and sends the output to the second AdaIN sub-layer 120-2. The output of the second convolution sub-layer 120-6 may be the output of the second layer 120.

In some examples, each second layer of the one or more second layers may, but not limited to, include the same layer structure as the second layer 120. In some examples, a last layer of the one or more second layers may generate its output as an output image of the fine-grained style-based generator 100.

As shown in FIG. 3, the affine transform layer 106-1 receives the intermediate FGSL from the second mapping network 103, generates an output and sends the output to the AdaIN sub-layer 120-1 in the second layer 120. The affine transform layer 106-2 receives the intermediate FGSL from the second mapping network 103, generates an output and sends the output to the AdaIN sub-layer 120-2 in the second layer 120.

In some examples, the first convolution sub-layer 120-7 or the second convolution sub-layer 120-6 may be a 3×3 convolution layer. The second layer 120 may process feature maps of a resolution of 216, 512, or 1024.

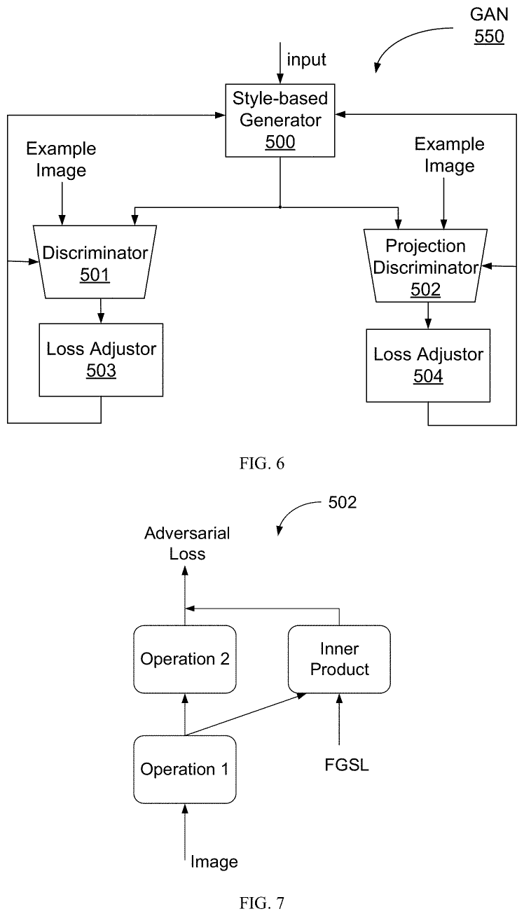

FIG. 6 illustrates an example of a GAN in accordance with some implementations of the present disclosure. A GAN 550 includes a style-based generator 500, a discriminator 501, a first loss adjustor 503, a projection discriminator 502, and a second loss adjustor 504. The style-based generator 500 may be the fine-grained style-based generator 100 shown in FIG. 3.

In some examples, the style-based generator 500 generates the output image and sends to the discriminator 501. Further, the discriminator 501 determines whether the output image generated by the style-based generator 500 matches an example image from training data. The example image may be the input image based on which the output image is generated by the style-based generator 500.

In some examples, the determination of whether the output image generated by the style-based generator 500 matches the example image may be based on a loss function indicating how similar or how consistent the output image and the example images are. Based on the determination, the first loss adjustor 503 adjusts parameters of the GAN 550 and the style-based generator 500 may then regenerate another output image for the input image until the discriminator 501 cannot distinguish the output image from the example image.

In some examples, the style-based generator 500 generates the output image and sends to the projection discriminator 502. Further, the projection discriminator 502 determines whether the output image generated by the style-based generator 500 matches an example image from training data based on a specific FGSL. The example image may be the input image of the style-based generator 500 and the specific FGSL is corresponding to the input image. The example image may be the input image based on which the output image is generated by the style-based generator 500.

FIG. 7 illustrates an example of a projection discriminator in accordance with some implementations of the present disclosure. As shown in FIG. 7, the projection discriminator 502 receives two inputs including an image and an FGSL associated with the image. Operation 1 shown in FIG. 7 may be a vector output function of its input, that is, a feature vector of the image. Operation 2 may be a scalar function. The projection discriminator 502 takes an inner product of the feature vector of the image and the FGSL, and further generates an adversarial loss based on the two inputs.

In some examples, the projection discriminator 502 may receive, at a first time, an output image of the style-based generator 500 and the FGSL associated with the output image, and generate a first adversarial loss. At a second time that subsequently follows the first time, the projection discriminator 502 may receive the example image from training data and the FGSL associated with the example image, and generate a second adversarial loss. The example image may be the input image that is inputted to the style-based generator 500 and the output image is generated based on the input image.

Based on the first and second adversarial losses respectively generated by the projection discriminator 502 at the first time and the second time, it is determined whether the output image matches the example image. In some examples, the determination of whether the output image generated by the style-based generator 500 matches the example image may be based on how close the first and second adversarial losses are. In some examples, the output image generated by the style-based generator 500 is determined to be matching the example image when the first adversarial loss equals to the second adversarial loss. In some examples, the first and second adversarial losses do not have to be exactly the same to determine that the output image matches the example image. For example, when the difference between the first and the second adversarial losses are within a pre-determined range of difference, it is determined that the first adversarial loss matches the second adversarial loss. Based on the determination, when it is determined that the output image does not match the example image, the second loss adjustor 504 adjusts parameters of the GAN 550 and the style-based generator 500 may then regenerate another output image for the input image until the projection discriminator cannot distinguish the output image and the example image conditioned on FGSL.

In some examples, the GAN may include the projection discriminator 502 only. In some examples, the GAN may include both the projection discriminator 502 and the discriminator 501, and the determination made by the projection discriminator 502 and the discriminator 501 are both made. As a result, the use of the projection discriminator 502 provides a determination between the output image and the input image conditioned on FGSL. Thus, the output image generated by the style-based generator is consistent with the fine-grained style associated with the FGSL of the image inputted.

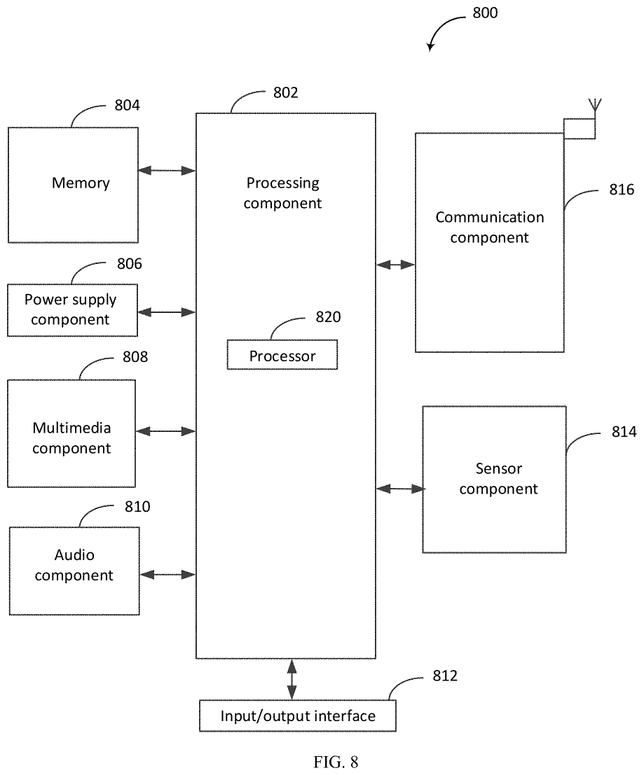

FIG. 8 is a block diagram illustrating an image processing system in accordance with some implementations of the present disclosure. The system 800 may be a terminal, such as a mobile phone, a tablet computer, a digital broadcast terminal, a tablet device, or a personal digital assistant.

As shown in FIG. 8, the system 800 may include one or more of the following components: a processing component 802, a memory 804, a power supply component 806, a multimedia component 808, an audio component 810, an input/output (I/O) interface 812, a sensor component 814, and a communication component 816.

The processing component 802 usually controls overall operations of the system 800, such as operations relating to display, a telephone call, data communication, a camera operation and a recording operation. The processing component 802 may include one or more processors 820 for executing instructions to complete all or a part of steps of the above method. The processors 820 may include CPU, GPU, DSP, or other processors. Further, the processing component 802 may include one or more modules to facilitate interaction between the processing component 802 and other components. For example, the processing component 802 may include a multimedia module to facilitate the interaction between the multimedia component 808 and the processing component 802.

The memory 804 is configured to store different types of data to support operations of the system 800. Examples of such data include instructions, contact data, phonebook data, messages, pictures, videos, and so on for any application or method that operates on the system 800. The memory 804 may be implemented by any type of volatile or non-volatile storage devices or a combination thereof, and the memory 804 may be a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk or a compact disk.

The power supply component 806 supplies power for different components of the system 800. The power supply component 806 may include a power supply management system, one or more power supplies, and other components associated with generating, managing and distributing power for the system 800.

The multimedia component 808 includes a screen providing an output interface between the system 800 and a user. In some examples, the screen may include a Liquid Crystal Display (LCD) and a Touch Panel (TP). If the screen includes a touch panel, the screen may be implemented as a touch screen receiving an input signal from a user. The touch panel may include one or more touch sensors for sensing a touch, a slide and a gesture on the touch panel. The touch sensor may not only sense a boundary of a touching or sliding actions, but also detect duration and pressure related to the touching or sliding operation. In some examples, the multimedia component 808 may include a front camera and/or a rear camera. When the system 800 is in an operation mode, such as a shooting mode or a video mode, the front camera and/or the rear camera may receive external multimedia data.

The audio component 810 is configured to output and/or input an audio signal. For example, the audio component 810 includes a microphone (MIC). When the system 800 is in an operating mode, such as a call mode, a recording mode and a voice recognition mode, the microphone is configured to receive an external audio signal. The received audio signal may be further stored in the memory 804 or sent via the communication component 816. In some examples, the audio component 810 further includes a speaker for outputting an audio signal.

The I/O interface 812 provides an interface between the processing component 802 and a peripheral interface module. The above peripheral interface module may be a keyboard, a click wheel, a button, or the like. These buttons may include but not limited to, a home button, a volume button, a start button and a lock button.

The sensor component 814 includes one or more sensors for providing a state assessment in different aspects for the system 800. For example, the sensor component 814 may detect an on/off state of the system 800 and relative locations of components. For example, the components are a display and a keypad of the system 800. The sensor component 814 may also detect a position change of the system 800 or a component of the system 800, presence or absence of a contact of a user on the system 800, an orientation or acceleration/deceleration of the system 800, and a temperature change of system 800. The sensor component 814 may include a proximity sensor configured to detect presence of a nearby object without any physical touch. The sensor component 814 may further include an optical sensor, such as a CMOS or CCD image sensor used in an imaging application. In some examples, the sensor component 814 may further include an acceleration sensor, a gyroscope sensor, a magnetic sensor, a pressure sensor, or a temperature sensor.

The communication component 816 is configured to facilitate wired or wireless communication between the system 800 and other devices. The system 800 may access a wireless network based on a communication standard, such as WiFi, 4G, or a combination thereof. In an example, the communication component 816 receives a broadcast signal or broadcast related information from an external broadcast management system via a broadcast channel. In an example, the communication component 816 may further include a Near Field Communication (NFC) module for promoting short-range communication. For example, the NFC module may be implemented based on Radio Frequency Identification (RFID) technology, infrared data association (IrDA) technology, Ultra-Wide Band (UWB) technology, Bluetooth (BT) technology and other technology.

In an example, the system 800 may be implemented by one or more of Application Specific Integrated Circuits (ASIC), Digital Signal Processors (DSP), Digital Signal Processing Devices (DSPD), Programmable Logic Devices (PLD), Field Programmable Gate Arrays (FPGA), controllers, microcontrollers, microprocessors or other electronic elements to perform the above method.

A non-transitory computer readable storage medium may be, for example, a Hard Disk Drive (HDD), a Solid-State Drive (SSD), Flash memory, a Hybrid Drive or Solid-State Hybrid Drive (SSHD), a Read-Only Memory (ROM), a Compact Disc Read-Only Memory (CD-ROM), a magnetic tape, a floppy disk and etc.

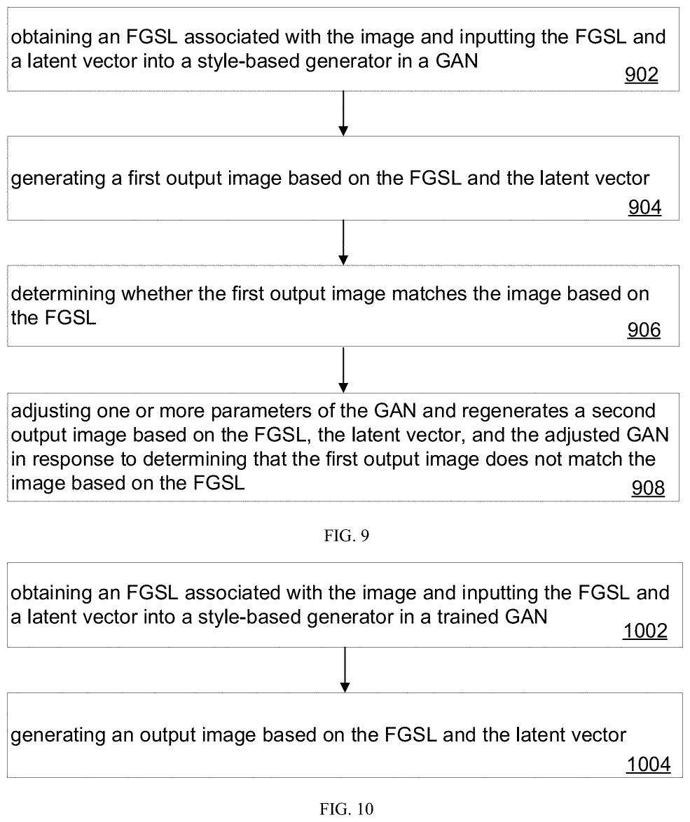

FIG. 9 is a flowchart illustrating an exemplary process of training a fine-grained style-based GAN in accordance with some implementations of the present disclosure.

In step 902, the processor 820 obtains an FGSL associated with the image and inputting the FGSL and a latent vector into a style-based generator in a GAN.

In some examples, the FGSL indicates one or more fine-grained styles of the image, and the GAN includes a projection discriminator.

In step 904, the processor 820 generates a first output image based on the FGSL and the latent vector.

In step 906, the processor 820 determines whether the first output image matches the image based on the FGSL.

In step 908, the processor 820 adjusts one or more parameters of the GAN and regenerates a second output image based on the FGSL, the latent vector, and the adjusted GAN in response to determining that the first output image does not match the image based on the FGSL.

In some examples, the processor 820 obtains the trained GAN in response to determining that the first output image matches the image based on the FGSL.

In some examples, the processor 820 generates a plurality of feature vectors by feeding one or more images into a VGG convolutional neural network.

In some examples, the plurality of feature vectors comprise a plurality of style representations of the one or more images in a high-dimension vector space, and the plurality of style representations are associated with the one or more fine-grained styles.

In some examples, the processor 820 obtains a Gram matrix by concatenating the plurality of feature vectors, obtains one or more FGSLs associated with the one or more images by reducing dimensions of the Gram matrix; and selects the FGSL from the one or more FGSLs.

In some examples, a distance between two FGSLs in the one or more FGSLs indicates whether two images corresponding to the two FGSLs match each other based on the one or more fine-grained styles.

In some examples, the one or more FGSLs indicate a gradient relationship of the one or more images based on the one or more fine-grained styles.

In some examples, the style-based generator comprises a first mapping network, a second mapping network, and a synthesis network comprising a plurality of layers, the plurality of layers comprise one or more first layers and one or more second layers, and the processor 820 generates an intermediate latent vector for the latent vector by the first mapping network, transforms the intermediate latent vector into one or more first style signals, generates an intermediate FGSL for the FGSL by the second mapping network, transforms the intermediate FGSL into one or more second style signals, feeds the one or more first style signals to the one or more first layers; feeds the one or more second style signals to the one or more second layers comprising a last second layer, and generates the first output image by the last second layer.

In some examples, the one or more second layers process higher resolution feature maps than the one or more first layers.

In some examples, a number of the one or more second layers is no greater than a number of the one or more first layers.

In some examples, the processor 820 calculates a first adversarial loss based on the image and the FGSL by the projection discriminator, calculates a second adversarial loss based on the first output image and the FGSL by the projection discriminator, and determines whether the first output image matches the image based on the first adversarial loss and the second adversarial loss by the projection discriminator.

In some examples, there is provided an apparatus for training a fine-grained style-based GAN. The apparatus includes one or more processors 820 and a memory 804 configured to store instructions executable by the one or more processors; where the processor, upon execution of the instructions, is configured to perform a method as illustrated in FIG. 9.

In some other examples, there is provided a non-transitory computer readable storage medium 804, having instructions stored therein. When the instructions are executed by one or more processors 820, the instructions cause the processor to perform a method as illustrated in FIG. 9.

FIG. 10 is a flowchart illustrating an exemplary process of processing an image by using a GAN that has been trained according to the method as illustrated in FIG. 9 in accordance with some implementations of the present disclosure.

In step 1002, the processor 820 obtains an FGSL associated with the image and inputting the FGSL and a latent vector into a style-based generator in a trained GAN obtained by the method as illustrated in FIG. 9.

In some examples, the FGSL indicates one or more fine-grained styles of the image.

In step 1004, the processor 820 generates an output image based on the FGSL and the latent vector.

In some examples, the processor 820 generates a plurality of feature vectors by feeding one or more images including the image being processed into a VGG convolutional neural network, obtains a Gram matrix by concatenating the plurality of feature vectors, and selects the FGSL from the one or more FGSLs.

In some examples, the plurality of feature vectors may include a plurality of style representations of the one or more images in a high-dimension vector space, and the plurality of style representations may be associated with the one or more fine-grained styles.

In some examples, the style-based generator may include a first mapping network, a second mapping network, and a synthesis network comprising a plurality of layers. The plurality of layers may include one or more first layers and one or more second layers.

In some examples, the processor 820 may generate an intermediate latent vector for the latent vector by the first mapping network, transform the intermediate latent vector into one or more first style signals, generate intermediate FGSL for the FGSL by the second mapping network, transform the intermediate FGSL into one or more second style signals, feeds the one or more first style signals to the one or more first layers and the one or more second style signals to the one or more second layers comprising a last second layer, and generate the output image by the last second layer.

In some examples, the one or more second layers process higher resolution feature maps than the one or more first layers

In some examples, there is provided an apparatus for processing an image by using a trained GAN obtained in the method as illustrated in FIG. 9. The apparatus includes one or more processors 820 and a memory 804 configured to store instructions executable by the one or more processors; where the processor, upon execution of the instructions, is configured to perform a method as illustrated in FIG. 10.

In some other examples, there is provided a non-transitory computer readable storage medium 804, having instructions stored therein. When the instructions are executed by one or more processors 820, the instructions cause the processor to perform a method as illustrated in FIG. 10.

The description of the present disclosure has been presented for purposes of illustration, and is not intended to be exhaustive or limited to the present disclosure. Many modifications, variations, and alternative implementations will be apparent to those of ordinary skill in the art having the benefit of the teachings presented in the foregoing descriptions and the associated drawings.

The examples were chosen and described in order to explain the principles of the disclosure, and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

What is claimed is:

1. A method for training a generative adversarial network (GAN), comprising:
obtaining a fine-grained style label (FGSL) associated with an image and inputting the FGSL and a latent vector into a style-based generator in the GAN, wherein the FGSL indicates one or more fine-grained styles of the image, and the GAN comprises a projection discriminator;
generating, by the style-based generator, a first output image based on the FGSL and the latent vector;
determining, by the projection discriminator, whether the first output image matches the image based on the FGSL; and
in response to determining that the first output image does not match the image based on the FGSL, adjusting one or more parameters of the GAN and regenerating, by the style-based generator, a second output image based on the FGSL, the latent vector, and the adjusted GAN.

2. The method according to claim 1, further comprising:
in response to determining that the first output image matches the image based on the FGSL, obtaining the trained GAN.

3. The method according to claim 1, further comprising:
generating a plurality of feature vectors by feeding one or more images into a VGG convolutional neural network, wherein the plurality of feature vectors comprise a plurality of style representations of the one or more images in a high-dimension vector space, and the plurality of style representations are associated with the one or more fine-grained styles;
obtaining a Gram matrix by concatenating the plurality of feature vectors;
obtaining one or more FGSLs associated with the one or more images by reducing dimensions of the Gram matrix; and
selecting the FGSL from the one or more FGSLs.

4. The method according to claim 3, wherein a distance between two FGSLs in the one or more FGSLs indicates whether two images corresponding to the two FGSLs match each other based on the one or more fine-grained styles.

5. The method according to claim 3, wherein the one or more FGSLs indicate a gradient relationship of the one or more images based on the one or more fine-grained styles.

6. The method according to claim 1, wherein
the style-based generator comprises a first mapping network, a second mapping network, and a synthesis network comprising a plurality of layers, wherein the plurality of layers comprise one or more first layers and one or more second layers; and
the method further comprises:
generating, by the first mapping network, an intermediate latent vector for the latent vector;
transforming the intermediate latent vector into one or more first style signals;
generating, by the second mapping network, an intermediate FGSL for the FGSL;
transforming the intermediate FGSL into one or more second style signals;
feeding the one or more first style signals to the one or more first layers;
feeding the one or more second style signals to the one or more second layers comprising a last second layer; and
generating, by the last second layer, the first output image.

7. The method according to claim 6, wherein the one or more second layers process higher resolution feature maps than the one or more first layers.

8. The method according to claim 7, wherein a number of the one or more second layers is no greater than a number of the one or more first layers.

9. The method according to claim 1, wherein determining, by the projection discriminator, whether the first output image matches the image based on the FGSL comprises:
calculating, by the projection discriminator, a first adversarial loss based on the image and the FGSL;
calculating, by the projection discriminator, a second adversarial loss based on the first output image and the FGSL; and
determining, by the projection discriminator, whether the first output image matches the image based on the first adversarial loss and the second adversarial loss.

10. A method for processing an image, comprising:
obtaining a fine-grained style label (FGSL) associated with the image and inputting the FGSL and a latent vector into a style-based generator in a generative adversarial network (GAN), wherein the FGSL indicates one or more fine-grained styles of the image; and
generating, by the style-based generator, an output image based on the FGSL and the latent vector.

11. The method according to claim 10, wherein obtaining the FGSL associated with the image comprises:
generating a plurality of feature vectors by feeding one or more images into a VGG convolutional neural network, wherein the plurality of feature vectors comprise a plurality of style representations of the one or more images in a high-dimension vector space, and the plurality of style representations are associated with the one or more fine-grained styles;
obtaining a Gram matrix by concatenating the plurality of feature vectors;
obtaining one or more FGSLs associated with the one or more images by reducing dimensions of the Gram matrix; and
selecting the FGSL from the one or more FGSLs.

12. The method according to claim 11, wherein
the style-based generator comprises a first mapping network, a second mapping network, and a synthesis network comprising a plurality of layers, wherein the plurality of layers comprise one or more first layers and one or more second layers; and
the method further comprises:
generating, by the first mapping network, an intermediate latent vector for the latent vector;
transforming the intermediate latent vector into one or more first style signals;
generating, by the second mapping network, an intermediate FGSL for the FGSL;
transforming the intermediate FGSL into one or more second style signals;
feeding the one or more first style signals to the one or more first layers;
feeding the one or more second style signals to the one or more second layers comprising a last second layer; and
generating, by the last second layer, the output image.

13. The method according to claim 12, wherein the one or more second layers process higher resolution feature maps than the one or more first layers.

14. An apparatus for training a generative adversarial network (GAN), comprising:
one or more processors; and
a memory configured to store instructions executable by the one or more processors;
wherein the one or more processors, upon execution of the instructions, are configured to perform acts comprising:
obtaining a fine-grained style label (FGSL) associated with an image and inputting the FGSL and a latent vector into a style-based generator in the GAN, wherein the FGSL indicates one or more fine-grained styles of the image, and the GAN comprises a projection discriminator;
generating, by the style-based generator, a first output image based on the FGSL and the latent vector;
determining, by the projection discriminator, whether the first output image matches the image based on the FGSL; and
in response to determining that the first output image does not match the image based on the FGSL, adjusting one or more parameters of the GAN and regenerating, by the style-based generator, a second output image based on the FGSL, the latent vector, and the adjusted GAN.

15. The apparatus according to claim 14, wherein the one or more processors are configured to perform acts further comprising:
in response to determining that the first output image matches the image based on the FGSL, obtaining the trained GAN.

16. The apparatus according to claim 14, wherein the one or more processors are configured to perform acts further comprising:
generating a plurality of feature vectors by feeding one or more images into a VGG convolutional neural network, wherein the plurality of feature vectors comprise a plurality of style representations of the one or more images in a high-dimension vector space, and the plurality of style representations are associated with the one or more fine-grained styles;
obtaining a Gram matrix by concatenating the plurality of feature vectors;
obtaining one or more FGSLs associated with the one or more images by reducing dimensions of the Gram matrix; and
selecting the FGSL from the one or more FGSLs.

17. The apparatus according to claim 16, wherein a distance between two FGSLs in the one or more FGSLs indicates whether two images corresponding to the two FGSLs match each other based on the one or more fine-grained styles.

18. The apparatus according to claim 16, wherein the one or more FGSLs indicate a gradient relationship of the one or more images based on the one or more fine-grained styles.

19. The apparatus according to claim 14, wherein the style-based generator comprises a first mapping network, a second mapping network, and a synthesis network comprising a plurality of processing layers, wherein the plurality of processing layers comprise one or more first processing layers and one or more second processing layers; and
the one or more processors are configured to perform acts further comprising:
generating, by the first mapping network, an intermediate latent vector for the latent vector;
transforming the intermediate latent vector into one or more first style signals;
generating, by the second mapping network, an intermediate FGSL for the FGSL;
transforming the intermediate FGSL into one or more second style signals;
feeding the one or more first style signals to the one or more first layers;
feeding the one or more second style signals to the one or more second layers comprising a last second layer; and
generating, by the last second layer, the first output image.

20. The apparatus according to claim 14, wherein determining, by the projection discriminator, whether the first output image matches the image based on the FGSL comprises:
calculating, by the projection discriminator, a first adversarial loss based on the image and the FGSL;
calculating, by the projection discriminator, a second adversarial loss based on the first output image and the FGSL; and
determining, by the projection discriminator, whether the first output image matches the image based on the first adversarial loss and the second adversarial loss.
